(19) United States
(12) Patent Application Publication
(10) Pub. No.: US 2026/0017388 A1
(43) Pub. Date: Jan. 15, 2026

(54) Dynamic Integrity and Data Encryption (IDE) Aggregation Size

(71) Applicant: Sandisk Technologies, Inc., Milpitas, CA (US)

(72) Inventor: Shay BENISTY, Beer Sheva (IL)

(73) Assignee: Sandisk Technologies, Inc., Milpitas, CA (US)

(21) Appl. No.: 18/770,407

(22) Filed: Jul. 11, 2024

(51) Int. Cl. G06F 21/60; G06F 21/55; G06F 21/64

(52) U.S. Cl. CPC G06F 21/602; G06F 21/554; G06F 21/64

(57) ABSTRACT

To reduce bandwidth overheads associated with a message authentication code (MAC), aggregation is useful. To ensure there is no latency impact, something more than aggregation is needed. Integrity and Data Encryption (IDE) securing transaction layer packets (TLPs) can be used in a dynamic manner whereby before aggregating a new packet to the IDE TLP, a determination is made regarding whether the packet contains user data so that the packets with user data can be sent immediately rather than wanting for more packets to aggregate. On the receiving side, execution of the packet can occur before completing an integrity check that occurs in IDE TLP transfers to reduce latency.

### BACKGROUND OF THE DISCLOSURE

### Field of the Disclosure

Embodiments of the present disclosure generally relate to improved Integrity and Data Encryption (IDE) securing transaction layer packet (TLP) aggregation and processing.

### Description of the Related Art

Data integrity and confidentiality are critical to a secure computational environment. A secured “edge-to-core” infrastructure, covering everything from the end user to the data center, is paramount to the protection against attacks from malicious actors. The peripheral component interconnect (PCI) express (PCIe) technology is integral to high-speed flow of information. The PCI-SIG has recognized the importance of secured data transfers with the introduction of Integrity and Data Encryption (IDE) capabilities to the PCIe specification. IDE may sometimes be referred to as link encryption.

IDE provides confidentiality, integrity, and replay protection for transaction layer packets (TLPs). IDE flexibly supports a variety of use models, while providing broad interoperability. The cryptographic mechanisms are aligned to current industry best practices and can be extended as security requirements evolve. Generally speaking, all of the packets that are going to be transferred over a link will be encrypted and have data integrity protection.

The security model considers threats from physical attacks on links, including cases where an adversary uses lab equipment, purpose-built interposers, malicious extension devices, etc. to examine data intended to be confidential, modify TLP contents, and reorder and/or delete TLPs. TLP traffic can be secured as TLPs transit switches, extending the security model to address threats from reprogramming switch routing mechanisms or using “malicious” switches.

There is a need in the art for improved IDE TLP aggregation and processing.

### SUMMARY OF THE DISCLOSURE

To reduce bandwidth overheads associated with a message authentication code (MAC), aggregation is useful. To ensure there is no latency impact, something more than aggregation is needed. Integrity and Data Encryption (IDE) securing transaction layer packets (TLPs) can be used in a dynamic manner whereby before aggregating a new packet to the IDE TLP, a determination is made regarding whether the packet contains user data so that the packets with user data can be sent immediately rather than wanting for more packets to aggregate. On the receiving side, execution of the packet can occur before completing an integrity check that occurs in IDE TLP transfers to reduce latency.

In one embodiment, a data storage device comprises: a memory device; and a controller coupled to the memory device, wherein the controller is configured to: create an IDE TLP using a first TLP and a second TLP, wherein the IDE TLP includes an IDE TLP MAC; prepare a third TLP; determine whether to aggregate the third TLP with the first TLP and the second TLP; and send the IDE TLP MAC to a host device with a last TLP.

In another embodiment, a data storage device comprises: a memory device; and a controller coupled to the memory device, wherein the controller is configured to: receive a first chunk of an IDE TLP; determine whether the first chunk is the last chunk of the IDE TLP; determine if the first chunk is a non-user data packet; and perform speculative usage of the IDE TLP before completing a protection check. If any chunk contains data, execution may continue. For example, the chunk can be encrypted. If at a later point in time the chunk is determined to be a bad packet, the encrypted data will be ignored.

In another embodiment, a data storage device comprises: means to store data; and a controller coupled to the means to store data, wherein the controller is configured to: determine whether to aggregate data packets based upon whether the packet contains non-user data; directly post a first packet to a host device without aggregating packets if the packet contains non-user data; and perform speculative usage of a second packet before completing a protection check of the second packet.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of an Integrity and Data Encryption (IDE) securing transaction layer packets (TLPs) between ports according to one embodiment.

FIG. 3 is a schematic illustration of an IDE TLP without aggregation.

FIG. 4 is a schematic illustration of an IDE TLP with aggregation.

FIG. 5 is a flowchart illustrating dynamic IDE TLP aggregation according to one embodiment.

FIG. 6 is a flowchart illustrating speculative usage of TLPs before protection check completion.

FIG. 7 is a system block diagram according to one embodiment.

FIG. 8 is a flowchart illustrating dynamic IDE TLP aggregation according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

To reduce bandwidth overheads associated with a message authentication code (MAC), aggregation is useful. To ensure there is no latency impact, something more than aggregation is needed. Integrity and Data Encryption (IDE) securing transaction layer packets (TLPs) can be used in a dynamic manner whereby before aggregating a new packet to the IDE TLP, a determination is made regarding whether the packet contains user data so that the packets with user data can be sent immediately rather than wanting for more packets to aggregate. On the receiving side, execution of the packet can occur before completing an integrity check that occurs in IDE TLP transfers to reduce latency.

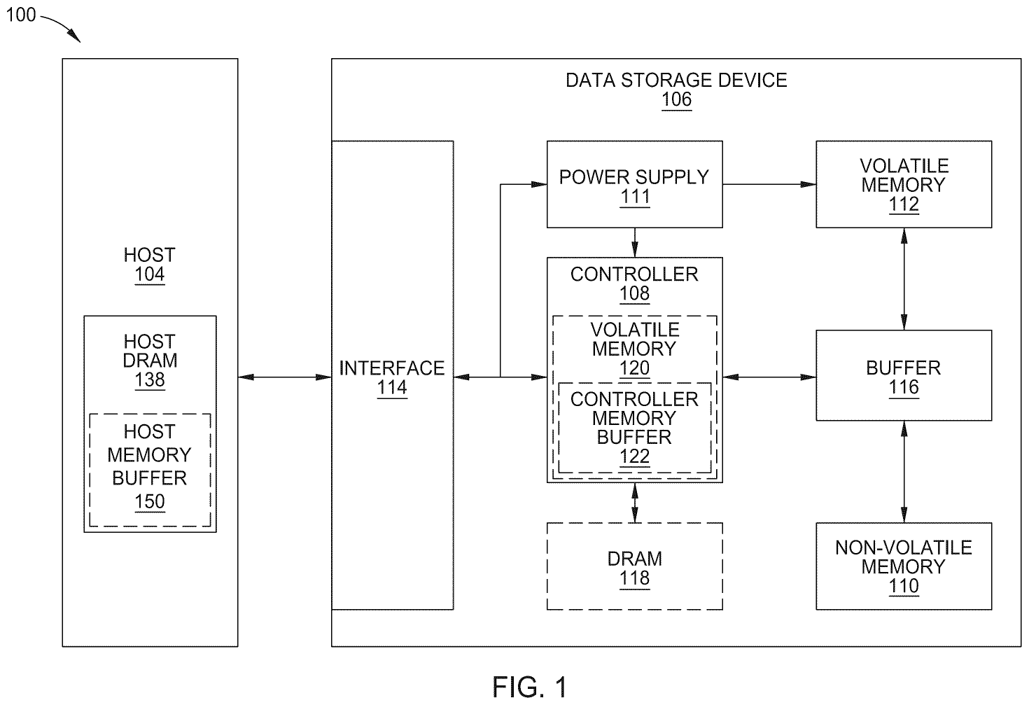

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

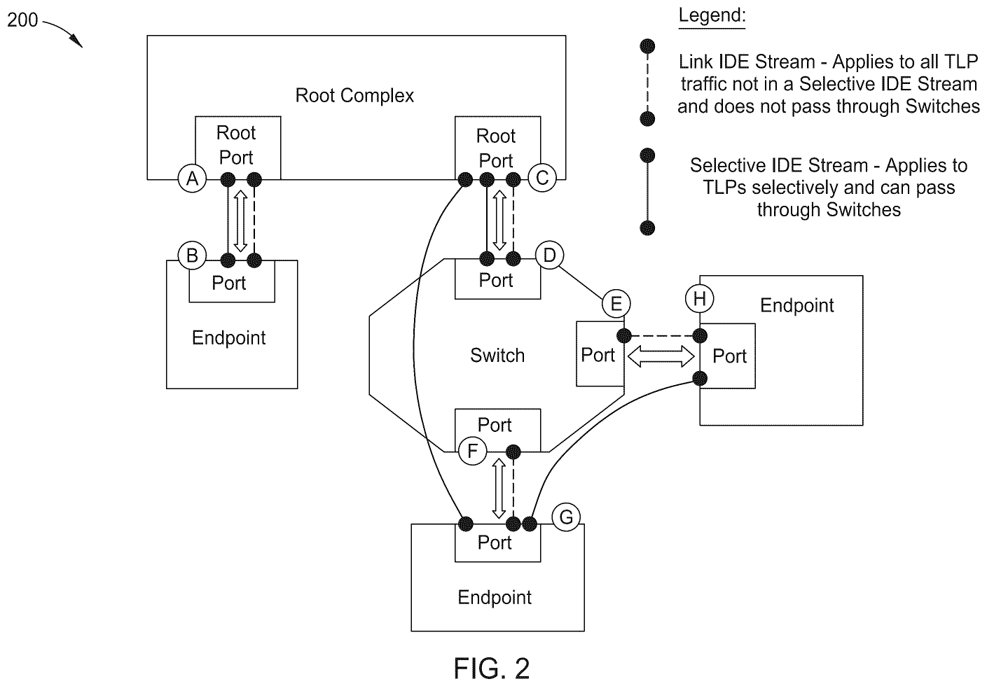

FIG. 2 is a schematic illustration 200 of an IDE securing TLPs between ports according to one embodiment. IDE establishes an IDE Stream between two ports as illustrated in FIG. 2. In FIG. 2, the root complex for the system is visible. There are several endpoints shown as well as a switch and items that are related to IDE. There are two main related features: the link IDE stream and the selective IDE stream.

The difference between the link IDE stream and the selective IDE stream is in the protection and security. For the IDE stream, the protection and security is point to point (e.g., port to port) whereas for the selective IDE stream, the protection and security is throughout and can pass through switches. In the example shown in FIG. 2, there is shown a root port and a port of a switch. Between Ports A and B, the link IDE stream and the selective IDE stream are both protected and secured, but at there is only a port to port situation, the protection has the same effect regardless of whether linked IDE steam or selective IDE stream is used. The same applies between Ports C and D, Ports F and G, and Ports E and H. However, if going from Port C to Port G or Port G to Port H, the selective IDE stream is protected across the switch. More specifically, for link IDE streams, the switch will be able to decrypt the link IDE stream and hence see everything in a transmission packet that is transmitted from Port C to Port D, Port D to Port C, Port F to Port G, Port G to Port F, Port E to Port H, and Port H to Port E. For the selective IDE stream, however, it is different in that the switch will not be able to decrypt the packets sent from Port C to Port G or Port G to Port H.

When there are no switches between the ports, then it is possible to secure all, or only selected, TLP traffic on the link, using link IDE streams or selective IDE streams, respectively. There is no required relationship, or restriction, between link IDE streams and selective IDE streams. It is possible to use both link IDE streams and selective IDE streams between two directly connected ports, as shown between Ports A and B, in which case TLPs associated with the selective IDE stream are secured using that stream's key set, and all other TLPs are secured using the key set for the link IDE stream. Such a configuration may be desirable if, for example, different security policies are applied to the selective IDE TLPs than to other link traffic. It is possible to use selective IDE streams in cases where the IDE terminus is a switch port, as shown between Ports C and D. IDE does not establish security beyond the boundary of the two terminal ports. Again, referring to the example shown in FIG. 2, the selective IDE streams between Ports C and G, and between Ports G and H, are secured as they pass through the switch. All other link IDE and selective IDE streams illustrated are secured by IDE from port to port, but must be secured by implementation-specific means within the component past the terminal port.

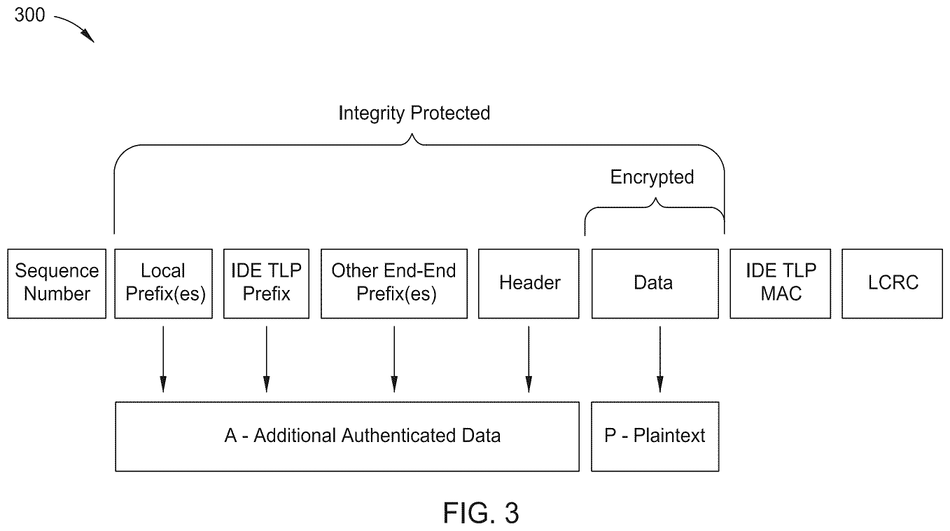

AES-GCM is applied for encryption of TLP data payload and authenticated integrity protection of entire TLP. For IDE TLPs, AES-GCM can be applied to each IDE TLP, or aggregation can be used to apply AES-GCM to multiple IDE TLPs, reducing the per-TLP overhead for the IDE TLP MAC. FIG. 3 is a schematic illustration of an IDE TLP 300 without aggregation.

The packet includes a sequence number. The packet may include a local prefix as shown. Oftentimes there are other prefixes such as an IDE TLP prefix as well as other end to end prefixes as shown. The packet also includes the header and the payload. The payload is dependent upon what type of packet is present such as: memory read, memory write configuration, read, write, etc. In FIG. 3, the payload is data (e.g., user data). Because the payload is data in FIG. 3, the data is encrypted. Additionally, the prefixes, header, and data is all protected though the prefixes and header are not encrypted. The protection is with a signature which is the IDE TLP message authentication code (MAC). If there is a bit flip or something like that, the logic will detect the flip. LCRC may also be present as shown in FIG. 3. To summarize, the packet of FIG. 3 includes a data payload that is encrypted and protected. Just the payload is encrypted and the rest of the packet is protected, but not encrypted. The header and prefixes are not encrypted, but all of them, including the payload would be used for the integrity protection in order to generate the IDE TLP MAC.

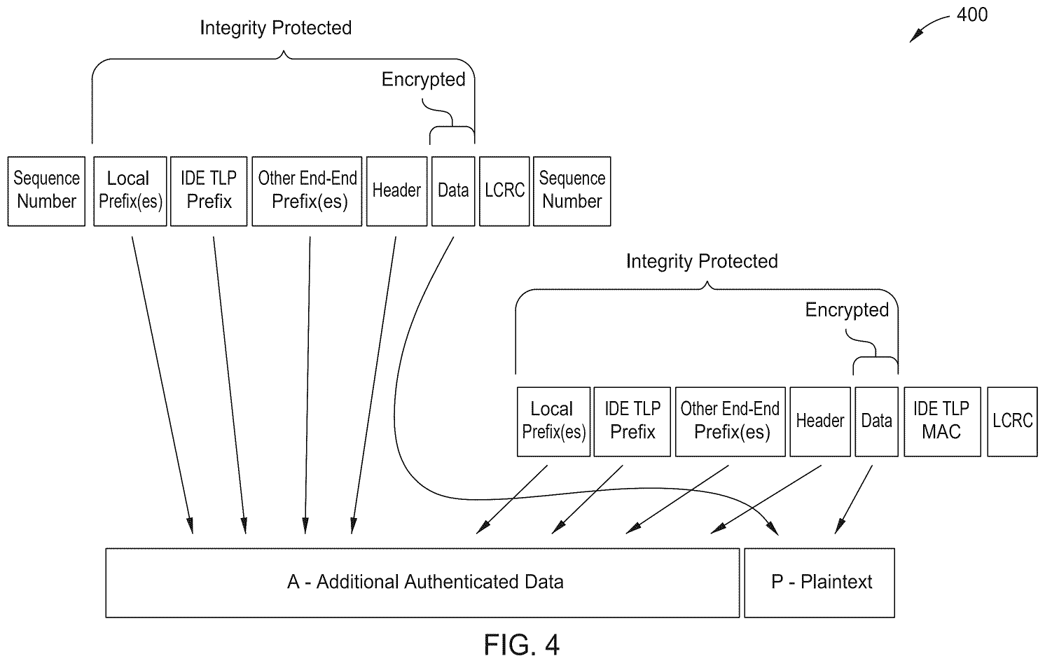

FIG. 4 is a schematic illustration 400 of an IDE TLP with aggregation. FIG. 4 exemplifies two packets that share the IDE TLP MAC. In the first packet, the data is encrypted, and in the second packet, the data is encrypted. The PCIe IDE feature allows aggregating several packets and having a single IDE TLP MAC for all of them. In one embodiment, up to eight packets can be aggregated together and use a single IIDE TLP MAC for the aggregated packet instead of individual IDE TLP MACs. It is better to aggregate several packets and have a single IDE TLP MAC for eight packets as opposed to having single packets each with a dedicated IDE TLP MAC from a performance perspective. It is better for performance and bandwidth efficiency because there will be less overhead transferred over the link. The drawback is that once the receiver receives the first packet, the receiver will not be able to do anything with the first packet because the IDE TLP MAC has not been received and thus the integrity check will fail if the first packet is executed prior to receiving the IDE TLP MAC. It is only after all packets have transferred that the IDE TLP MAC will be transferred. Only at that point will it be possible to ensure that there is no error in in the aggregated packets, which increases the latency. In the worst case scenario of eight packets aggregated together, seven more packets will need to arrive before performing the integrity check for the first packet.

To reduce the bandwidth overhead associated with the IDE TLP MAC, the use of aggregation is encouraged. On the other hand, aggregation may increase the latency for a receiver to make use of the received TLPs. The embodiments discussed herein address the problem of aggregation usage and the system impact. The goal is to achieve the benefit of aggregation without adding latency.

The disclosure will focus on two parts, the transmission side and the receiving side, which operate in parallel. Broadly speaking, on the transmission side, before aggregating a packet, a check occurs to determine the importance of the latency for the specific packet. If the latency is not important, the packet will be aggregated, but if the latency is critical, the aggregation stops and the packet is sent along with the IDE TLP MAC to a host device. The aggregation can be restarted after the IDE TLP MAC is sent. The same process occurs for each packet. On the receiver side, if the latency is critical, speculatively execute the packet even before receiving the IDE TLP MAC. In a few microseconds, it will be possible to determine if the packet is fails a protection check or not. If the packet passes the protection check, then the speculative execution will reduce latency. If the packet fails the protection check, then there is no harm in the speculative execution.

More specifically, the packet aggregation and transmission is dynamic utilizing the IDE TLP aggregation feature. There are two basic elements of the dynamic nature of the disclosure, the transmission (e.g., Tx) side and the receiving (e.g., Rx) side. In the Tx side, the device controller does not just aggregate the TLPs statically. Instead, the device controller considers the type of the NVMe transaction. If the transaction is a transaction that is sensitive to latency, the packet is not aggregated so the host side will not need to pay in latency until parsing the packet. Only the non-critical packets are aggregated (i.e., packets that hold user data). In the Rx side, the device controller starts parsing partial IDE packets, even before getting the entire packet and not being able to validate the partial packets. The device controller identifies and classifies whether the partial packet is a critical packet or not. If a partial packet is a critical packet, the partial packet may start the execution phase in a speculative way. The method utilizes the IDE TLP aggregation feature in a way that enables obtaining the performance benefit while not paying in latency in the sensitive scenarios.

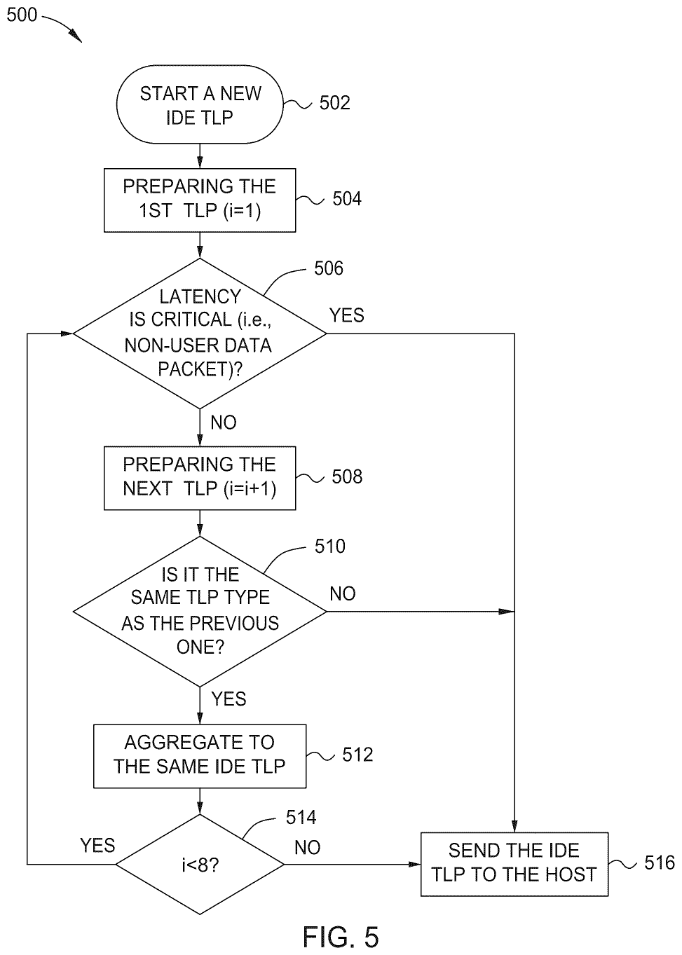

FIG. 5 is a flowchart 500 illustrating dynamic IDE TLP aggregation according to one embodiment. FIG. 5 describes the dynamic IDE aggregation method. At a high level, the flow starts by preparing the next TLP to be posted on the Tx side. If the latency of the packet is critical, the packet is posted directly to the host without aggregating more packets. If not, device controller collects the next TLP and aggregates the packet. If the packet becomes critical, the packet will be posted immediately to the host. Otherwise, the device controller aggregates more packets with the limit of a maximum of eight aggregated packets.

The method starts as block 502 where a new IDE TLP is started followed by preparing the first TLP and setting “i” to a value of 1 at block 504. The value of “i” is a tracking of the number of packets in the IDE TLP. At block 506, a determination is made regarding the criticality of the packet. If the latency is critical, then the IDE TLP is sent to the host at block 516. If not critical, then the next TLP is prepared at block 508 and “i” is increased to “i+1”. The motivation is to reduce latency for critical data. For non-critical data, latency, while still important, is less important. User data is typically considered non-critical data. Control messages such as doorbells and interrupts are considered critical data. In one embodiment, the address and size of the packets is used to determine whether the data is critical or non-critical. Short packets are critical unless the addresses are continuous with long packets. A determination is then made at block 510 regarding whether the next TLP that was just prepared is the same type of TLP as the previous TLP. If not the same, then aggregation ends and the method proceeds to block 516. If the TLP is the same type, then the aggregation continues at block 512. If “i” is less than eight at block 514, the aggregation continues. If “i” is not less than eight, then the method continues to block 516. Basically, aggregating will continue up until the maximum packet size is achieved or if something is detected that is critical for latency at which point the aggregation will stop and the IDE TLP is sent to the host after which the aggregation is restarted with a new IDE TLP.

As a specific example, if there are four packets that have already been aggregated and the fifth packet is prepared and determined to be critical, the aggregation is stopped. The first four packets have already been sent to the host, but the IDE TLP MAC has not been sent. What occurs is the fifth packet is sent to the host as is the IDE TLP MAC. The next packet (i.e., the sixth packet) will not use the same ID sequence but instead will be the first packet of a new IDE TLP.

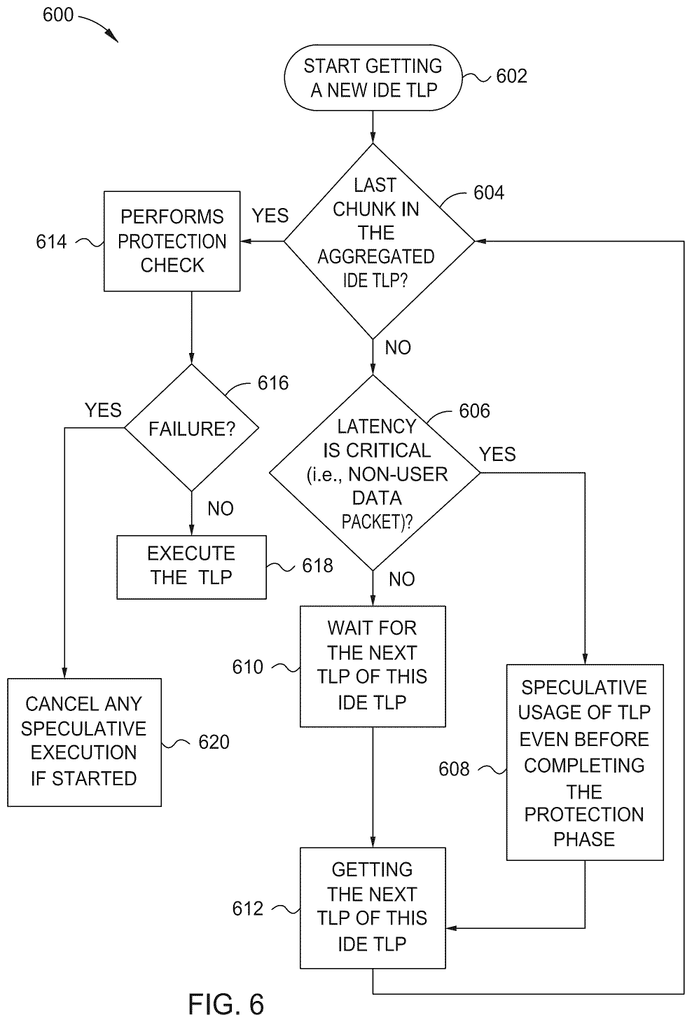

FIG. 6 is a flowchart 600 illustrating speculative usage of TLPs before protection check completion. FIG. 6 describes the speculative TLP execution in the Rx path. Broadly speaking, the flow starts by starting to receive a new IDE TLP or, more specifically, a first packet of a new IDE TLP. If the IDE TLP is not a last chunk of an aggregated IDE TLP, the device controller identifies whether the packet is critical. If the packet is critical, the device controller may start the execution of part of the TLP (i.e., the just received packet) even before completing the integrity check. The execution is a speculative execution since later the logic may detect an integrity issue in the packet. If the packet is not a critical TLP, the device waits for the next chunk of the IDE TLP, and ultimately the IDE TLP MAC. The flow repeats until receiving the entire IDE TLP. Then, the integrity check is performed, and if a failure is detected, the speculative execution associated with the IDE TLP are cancelled.

The method starts by initially beginning to receive a new IDE TLP at block 602. A determination is made at block 604 regarding whether the packet received in the new IDE TLP is the last chunk in an aggregated IDE TLP. If yes, then the controller performs a protection check at block 614. If the packet is not the last chunk, then a determination is made at block 606 regarding whether latency is critical (i.e., non-user data packet). If latency is critical, the speculative usage of the TLP begins even before completing the protection phase at block 608. After beginning the speculative usage of the TLP at block 608, the controller starts receiving a next TLP at block 612. If latency is not critical, then the controller waits for the next TLP of the IDE TLP to arrive at block 610 and then receives the next IDE TLP at block 612 before repeating block 604. Upon performing the protection check at block 614, a determination is made at block 616 regarding whether the protection check fails. If there is no failure, then the TLP is executed at block 618. If there is a failure, then any speculative execution is cancelled at block 620.

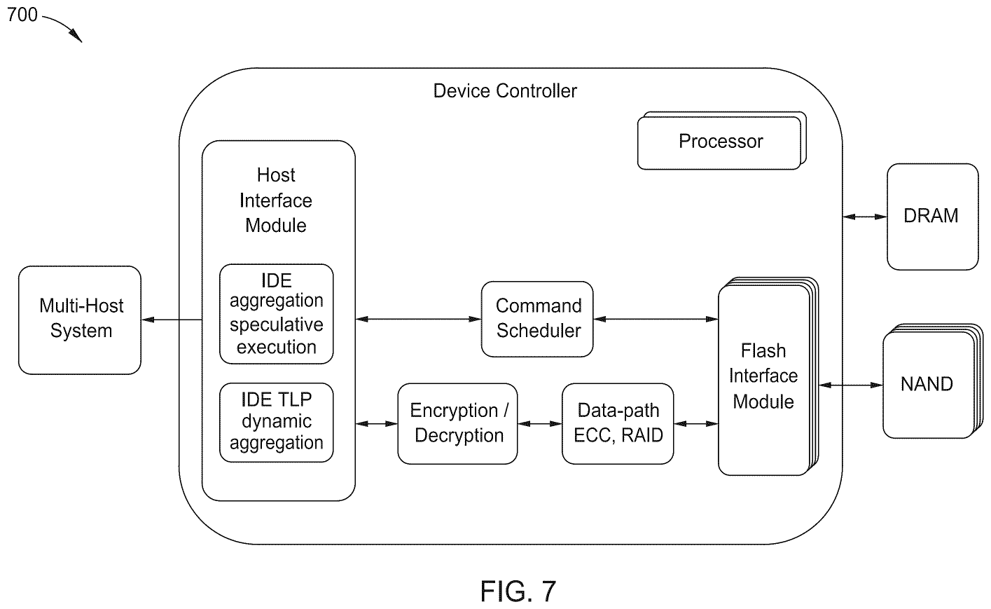

FIG. 7 is a system block diagram according to one embodiment. The system 700 includes a multi host system, a device controller, volatile memory such as DRAM, and nonvolatile memory such as NAND. The device controller includes a host interface module (HIM), one or more processors, one or more flash interface modules (FIM), a command scheduler, an encryption/decryption module, and a data path with error correction (ECC) capabilities and a RAID. The HIM includes an IDE TLP dynamic aggregation module and an IDE aggregation speculative execution module. The IDE TLP dynamic aggregation module is responsible for aggregating separately the latency critical and non-critical TLPs on the Tx side. The IDE aggregation speculative execution module is responsible for the identification of the critical TLPs on the Rx side and the decision whether to start speculative execution even before completing the protection check for the aggregated IDE packet. Either the IDE TLP dynamic aggregation module, the IDE aggregation speculative execution module, or both may be present.

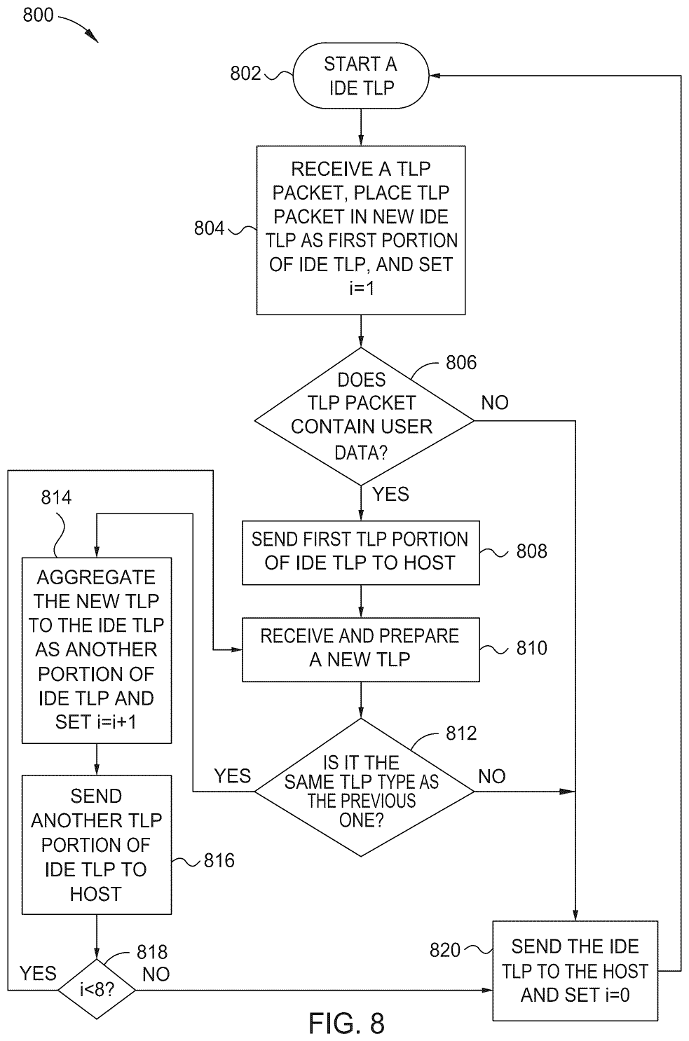

FIG. 8 is a flowchart 800 illustrating dynamic IDE TLP aggregation according to another embodiment. The method begins at block 802 when a new IDE TLP is started. A TLP packet is received and placed in the new IDE TLP as the first portion (or packet) of the IDE TLP and “i” is set to 1 at block 804. A determination is made at block 806 regarding whether the TLP packet contains user data. If the packet contains non-user data, then the IDE TLP is sent to the host at block 820 and “i” is reset to 0 and the process begins again at block 802. If the packet contains user data, then the first TLP portion is sent to the host at block 808 and a new TLP is received and prepared at block 810. A determination is made at block 812 regarding whether the new TLP is the same type as the previous TLP. If no, then the method proceeds to block 820. If yes, then the method proceeds to block 814 where the new TLP is aggregated as another portion of the IDE TLP and “i” is set to “i+1”. The another TLP is then sent to the host at block 816 and a determination is made regarding whether “i” is less than 8. If “i” is less than 8, then the method proceeds back to block 810 and the IDE TLP continues to aggregate more packets. If “i” is not less than 8, then the method proceeds to block 820.

The main advantage is utilizing the IDE aggregation TLP feature and increasing the overall performance while not increasing the latency in the latency sensitive TLPs.

In one embodiment, a data storage device comprises: a memory device; and a controller coupled to the memory device, wherein the controller is configured to: create an IDE TLP using a first TLP and a second TLP, wherein the IDE TLP includes an IDE TLP MAC; prepare a third TLP; determine whether to aggregate the third TLP with the first TLP and the second TLP; and send the IDE TLP MAC to a host device with a last TLP where the last TLP can be either the third TLP or another TLP. The determining comprises determining whether the second TLP is a user data packet. Upon determining that the third TLP is a non-user data packet, the controller is configured to send the second TLP to the host device. The IDE TLP MAC is a signature for protecting the IDE TLP and wherein the signature is for the first TLP, the second TLP, and the third TLP. The controller is configured to aggregate the third TLP with the first TLP and the second TLP upon determining that the third TLP is a user data packet TLP. The controller is configured to aggregate up to eight TLPs into the IDE TLP. The IDE TLP comprises at least two integrity protected portions, at least two sequence numbers, and the IDE TLP MAC. A first integrity protected portion of the at least two integrity protected portions is for the first TLP, a second integrity protected portion of the at least two integrity protected portions is for the second TLP, a first sequence number of the at least two sequence numbers is for the first TLP, a second sequence number of the at least two sequence numbers if for the second TLP, and the IDE TLP MAC is for both the first TLP and the second TLP. The controller comprises a host interface module (HIM) that includes an IDE TLP dynamic aggregation module. The controller comprises a HIM that includes an IDE aggregation speculation execution module. The controller is configured to start speculative usage of another IDE TLP before completing a protection check.

In another embodiment, a data storage device comprises: a memory device; and a controller coupled to the memory device, wherein the controller is configured to: receive a first chunk of an IDE TLP; determine whether the first chunk is the last chunk of the IDE TLP; determine if the first chunk is a non-user data packet; and perform speculative usage of the IDE TLP before completing a protection check. The controller is configured to wait for a second chunk upon determining that the first chunk is a non-data packet. The controller is configured to perform the speculative usage upon determining that the first chunk is not a non-data packet. The controller is configured to perform the protection check upon determining that the first chunk is the last chunk. The controller is configured to wait for a second chunk while performing the speculative usage. The controller is configured to encrypt the chunk and ignore the encrypted chunk if the chunk is determined to be a bad packet.

In another embodiment, a data storage device comprises: means to store data; and a controller coupled to the means to store data, wherein the controller is configured to: determine whether to aggregate data packets based upon whether the packet contains non-user data; directly post a first packet to a host device without aggregating packets if the packet contains non-user data; and perform speculative usage of a second packet before completing a protection check of the second packet. The controller is further configured to perform a protection check and cancel the speculative usage upon determining the protection check fails. The aggregated data packets are an IDE TLP that includes an IDE TLP MAC, wherein the IDE TLP MAC is a signature for protecting the IDE TLP, and wherein the signature is for all aggregated data packets of the IDE TLP.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
create an integrity and data encryption (IDE) transaction layer packet (TLP) using a first TLP and a second TLP, wherein the IDE TLP includes an IDE TLP message authentication code (MAC);
prepare a third TLP;
determine whether to aggregate the third TLP with the first TLP and the second TLP; and
send the IDE TLP MAC to a host device with a last TLP.

2. The data storage device of claim 1, wherein the determining comprises determining whether the second TLP is a user data packet.

3. The data storage device of claim 1, wherein upon determining that the second TLP is a non-user data packet, the controller is configured to send the second TLP to the host device.

4. The data storage device of claim 3, wherein the IDE TLP MAC is a signature for protecting the IDE TLP and wherein the signature is for the first TLP, the second TLP, and the third TLP.

5. The data storage device of claim 1, wherein the controller is configured to aggregate the third TLP with the first TLP and second TLP upon determining that the third TLP is a user data packet TLP.

6. The data storage device of claim 1, wherein the controller is configured to aggregate up to eight TLPs into the IDE TLP.

7. The data storage device of claim 6, wherein the IDE TLP comprises at least two integrity protected portions, at least two sequence numbers, and the IDE TLP MAC.

8. The data storage device of claim 7, wherein a first integrity protected portion of the at least two integrity protected portions is for the first TLP, a second integrity protected portion of the at least two integrity protected portions is for the second TLP, a first sequence number of the at least two sequence numbers is for the first TLP, a second sequence number of the at least two sequence numbers if for the second TLP, and the IDE TLP MAC is for both the first TLP and the second TLP.

9. The data storage device of claim 1, wherein the controller comprises a host interface module (HIM) that includes an IDE TLP dynamic aggregation module.

10. The data storage device of claim 1, wherein the controller comprises a host interface module (HIM) that includes an IDE aggregation speculation execution module.

11. The data storage device of claim 1, wherein the controller is configured to start speculative usage of another IDE TLP before completing a protection check.

12. A data storage device, comprising:
a memory device; and
a controller coupled to the memory device, wherein the controller is configured to:
receive a first chunk of an integrity and data encryption (IDE) transaction layer packet (TLP);
determine whether the first chunk is the last chunk of the IDE TLP;
determine if the first chunk is a non-user data packet; and
perform speculative usage of the IDE TLP before completing a protection check.

13. The data storage device of claim 12, wherein the controller is configured to wait for a second chunk upon determining that the first chunk is a non-data packet.

14. The data storage device of claim 12, wherein the controller is configured to perform the speculative usage upon determining that the first chunk is not a non-data packet.

15. The data storage device of claim 12, wherein the controller is configured to perform the protection check upon determining that the first chunk is the last chunk.

16. The data storage device of claim 12, wherein the controller is configured to wait for a second chunk while performing the speculative usage.

17. The data storage device of claim 12, wherein the controller is configured to encrypt the chunk and ignore the encrypted chunk if the chunk is determined to be a bad packet.

18. A data storage device, comprising:
means to store data; and
a controller coupled to the means to store data, wherein the controller is configured to:
determine whether to aggregate data packets based upon whether the packet contains non-user data;
directly post a first packet to a host device without aggregating packets if the packet contains non-user data; and
perform speculative usage of a second packet before completing a protection check of the second packet.

19. The data storage device of claim 18, wherein the controller is further configured to perform a protection check and cancel the speculative usage upon determining the protection check fails.

20. The data storage device of claim 18, wherein the aggregated data packets are an integrity and data encryption (IDE) transaction layer packet (TLP) that includes an IDE TLP media access controller (MAC), wherein the IDE TLP MAC is a signature for protecting the IDE TLP, and wherein the signature is for all aggregated data packets of the IDE TLP.
